(19) United States
(12) Patent Application Publication
(10) Pub. No.: US 2010/0112355 A1
(43) Pub. Date: May 6, 2010

(54) Aircraft Transparency

(75) Inventor: Brent Clothier, Wichita, KS (US)

Correspondence Address: LATHROP & GAGE LLP, 2345 GRAND Boulevard, SUITE 2400, KANSAS CITY, MO, 64108, US

(73) Assignee: Cessna Aircraft Company

(21) Appl. No.: 12/266,296

(22) Filed: Nov. 6, 2008

(51) Int. Cl. B32B 27/30; B29C 45/16

(52) U.S. Cl. 428/412; 156/243

(57) ABSTRACT

A hybrid polymeric aircraft transparency is disclosed. The transparency, e.g., window, is easier to maintain because scratches can be polished out of the surface. Further, the transparency is lighter in weight and relatively tough because it is constructed of polycarbonate layers instead of acrylics. The transparency is constructed using injection-compression-molding techniques.

### TECHNICAL FIELD

The present disclosed subject matter is related to aircraft, and in particular to aviation transparencies for applications such as windows and light covers for aircraft.

### BACKGROUND

The aviation industry is always looking for lighter weight materials to increase fuel efficiency. Accordingly, aviation transparencies, such as windows, for both the cabin and the cockpit have gone from glass to lightweight polymeric materials. The polymeric materials for these polymeric windows are routinely subject to scratches. It is extremely difficult, and sometimes not possible, to “rub out” these scratches. As a result, a scratched window must be completely replaced, which occurs regularly.

Aircraft window replacement is time consuming, and expensive. The windows themselves are expensive, as well as parts associated therewith are expensive. Second, changing these windows is a further expense as it is labor intensive and must be performed by skilled personnel, as it requires the sidewalls of the cabin to be removed to access the windows for replacement. Additionally, there is downtime and thus loss of service while the window is being replaced.

Other lightweight polymeric materials are used in aircraft, to replace heavier glass. For example, a hybrid material including polycarbonate and acrylic has been used as a landing light lens. However, this material lacks desireable optical properties.

### SUMMARY

The present disclosed subject matter improves on contemporary aviation transparencies, i.e., windows and landing light lenses, by providing a hybrid polymeric transparency for use in aircraft. This hybrid polymeric transparency possesses the requisite optical properties and impact resistance, that permit its use in aircraft as cockpit cabin windows landing light lenses, or in other applications. When the disclosed transparencies are used as aircraft windows, they are low-maintenance, as scratches can be polished out of the surface, allowing for minimal labor costs and minimal aircraft down time. Additionally, the disclosed transparencies are lighter in weight and tougher than conventional aviation transparencies. For example, by using polycarbonate layers, instead of acrylics, these polycarbonate layers being tougher than acrylics, thinner laminates may be used in the disclosed aircraft transparencies. This lighter weight contributes to fuel savings.

The present disclosed subject matter also provides methods for making aviation transparencies, such as aircraft windows with superior optical properties, over conventional aircraft windows, that are usable as both cockpit and cabin windows. For example, the windows are made by injection-compression molding techniques. These injection-compression molding techniques produce components for the windows with superior optics and lower residual stress, when compared to conventionally injection-molded components.

Another advantage to using an injection molding process is that it could enable the mounting features for the transparency, e.g., brackets, seals, etc., to be molded into the perimeter of the window.

An embodiment of the disclosed subject matter is directed to an aviation transparency. The aviation transparency includes a base, layer including a polycarbonate polymer, an upper layer including an acrylic polymer, and, an intermediate layer. The intermediate layer is a polymeric material for confining failures to the outer layer, and the intermediate layer is positioned between the base layer and the outer layer. The aviation transparency may be, for example, an aircraft window, such as a cockpit cabin window or a landing light lens.

### BRIEF DESCRIPTION OF THE DRAWINGS

Attention is now directed to the drawings, where like numerals and characters indicate like or corresponding components. In the drawings:

FIG. 1 is a perspective view of an airplane, showing cockpit and cabin windows;

FIG. 2 is a cross sectional view of cabin windows in accordance with the disclosed subject matter, taken along line 2-2 of FIG. 1; and,

FIG. 3 is a cross sectional view of cockpit windows in accordance with the disclosed subject matter, taken along line 3-3 of FIG. 1.

### DETAILED DESCRIPTION OF THE DRAWINGS

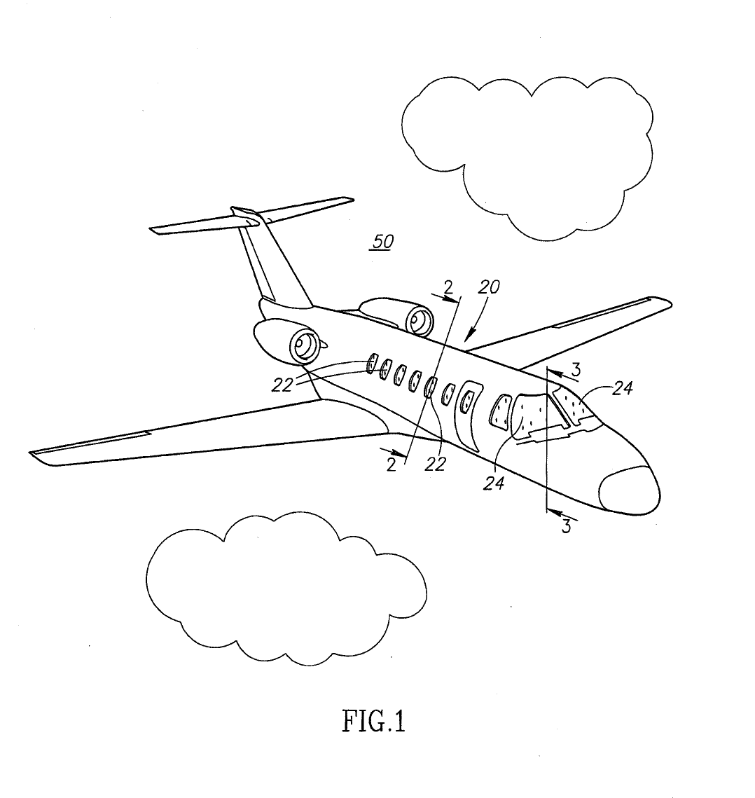

FIG. 1 shows an aircraft 20, with both cabin windows 22 and cockpit windows 24. These components must exhibit optical properties, allowing both pilots and passengers sufficient visibility from inside the aircraft, as well as standards for impact resistance and light transmittance. The visibility and impact resistance standards are, for example, set by U.S. Department of Transportation, Federal Aviation Administration Standards.

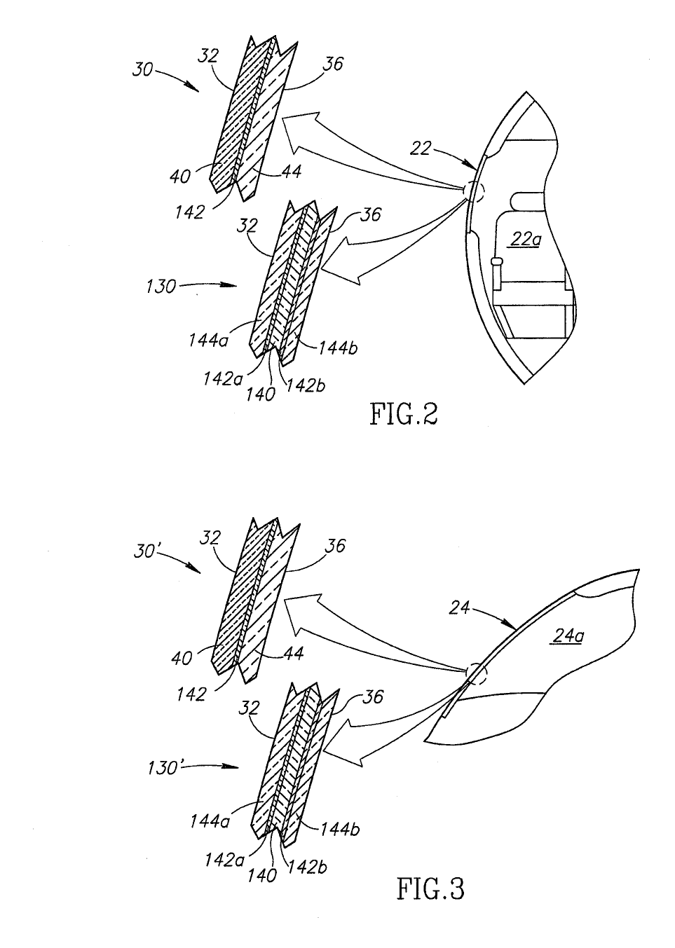

FIGS. 2 and 3 show cross-sections of windows 30, 30′, 130, 130′, exemplary of the disclosed subject matter. Windows 30, 130 are suitable for use as cabin windows 22 (as shown in the cabin 22a), and windows 30′, 130′ are suitable for use as cockpit windows 24 (shown in the cockpit 24a). The windows 30, 30′ shown in FIGS. 2 and 3 include three layers while the windows 130, 130′ of FIGS. 2 and 3 include five layers. Windows 30 and 130 are similar in construction to windows 30′ and 130′, respectively, but differ in that they are shaped differently to accommodate placement in the cabin 22a and cockpit 24a of the aircraft 22. While three and five layer structures are shown and described below, these constructions may include additional layers, adhesives, additives and the like, without departing from the disclosed three and five layer structures.

Turning specifically to FIGS. 2 and 3, the windows 30, 30′ include a base or base layer 44, a laminate or intermediate layer 142, and a top or outer layer 40. The windows 30, 30′ are oriented in an aircraft 20 or other vehicle, such that the base layer 44 faces the inside of the cabin 22a while the outer layer 40 faces the outside or ambient environment 50 (FIG. 1).

The base layer 44 is of a material such as a polycarbonate, and, for example, an optical grade polycarbonate, such as the polymer known as Polycarbonate GLX143, available from Exatec, a joint venture between Bayer and General Electric Plastics. The combination of the polycarbonate, acrylic and inner layer provides the windows 30, 30′ with the strength and impact resistance required by the aforementioned government regulations. The thickness may be approximately 0.115 inches to 0.265 inches, and may be, for example, a sheet of approximately 0.125 inches in thickness.

Polycarbonates are suitable as the base layer 44, as they are easily worked molded and thermoformed. The base layer 44 of polycarbonate is produced by injection-compression molding processes, and results in transparency that provides optical properties sufficient for cockpit and cabin windows. The resultant material also provides the necessary impact strength. Additionally, injection-compression molding allows for mounting structures, for example, brackets and seals to be molded onto the perimeter of the window 30, 30′ when it is finished, as detailed below.

The laminate or laminate layer 142 is, for example, of Polyvinyl butyral (PVB) resin, in a thin layer, film or sheet. This laminate layer 142 provides bonding between the base layer 44 and the top or outer layer 40, along with optical clarity, free of distortion. It is also tough and ductile, to confine cracks and other defects in the surrounding layers 40, 44, from passing through the laminate 30. The laminate layer 142 may be a PVB film, of materials such as Butacite®, Saflex®, S-Lec® and Trosifol®. Alternately, the laminate of the laminate or intermediate layer 142 may be a urethane. The laminate layer 142 may be of a thickness approximately 0.025 inches to 0.175 inches, e.g., 1 inch thick in an embodiment.

The top or outer layer 40 is, for example, of a Polymethyl Methacrylate (PMMA) (methyl 2-methylpropenoate), or other acrylic. The PMMA may be, for example, Polycast®, Plexiglas®, Perspex®, Plazcryl®, Acrylite®, Acrylplast®, Altuglas®, or Lucite®, or other acrylic. It is made, for example, by a casting process, and provides a surface from which scratches can be removed by polishing. The PMMA or other acrylic is also ultraviolet (UV) light resistant. The top or outer layer 40 may be of a thickness approximately 0.344 inches to 0.490 inches, e.g., 0.417 inches in an embodiment.

The windows 30, 30′ are manufactured by the following exemplary process. Initially, the polycarbonate base layer 44 and PMMA outer layer 40 are injection-compression molded as shells with corresponding configurations, so as to have nesting geometries. This molding as well as other processing steps are performed, for example, in a clean room. The PMMA layer 40 is placed on a tool and the nesting surface, opposite the tool, is coated with a primer, for example, an optically clear adhesion promoter.

After assembly the materials will be cured based on known standards, such as glass transition temperatures, as established by the manufacturers of the material and available in Material Specification Sheets from the respective manufacturers.

A thin precut sheet of PVB (that forms the laminate or intermediate layer 142) is placed onto the primed surface of the PMMA layer 40. A primer coating, for example, an optically clear adhesive, is placed onto the nesting surface of the polycarbonate base layer 44.

The now coated polycarbonate base layer 44 is placed into contact with the thin sheet of PVB (the laminate or intermediate layer 142) that covers the PMMA layer 40, to form an uncured product with three layers with flush edges.

The three layers are then cured, by being vacuum bagged in an autoclave. The vacuum bagging process is employed, as it allows for high temperature curing at elevated pressures, in oxygen-free environments.

Attention is now directed to alternate windows 130, 130′, that are suitable for use as cabin 22 and cockpit 24 windows. The windows 130, 130′ are formed of five layers 140, 142a, 142b, 144a, 144b.

The base layer 140 is similar in construction and materials to the base layer 44 detailed above. This base layer 140 is contacted on both sides by a laminate or laminate layer 142a, 142b, similar to the laminate layer 142 detailed above. Top or outer layers 144a, 144b are over the respective laminate layers 142a, 142b. These top or outer layers 144a, 144b are in accordance with the top or outer layer 40, as detailed above.

The windows 130, 130′ are manufactured by the following exemplary process. Initially, the polycarbonate base layer 140 and both PMMA outer layers 144a, 144b are injection-compression molded as shells with corresponding configurations, so as to have nesting geometries. This molding as well as other processing steps are performed, for example, in a clean room. One PMMA layer 144a is placed on a tool and the nesting surface, opposite the tool, is coated with a primer, for example, an optically clear adhesion promoter.

A thin precut sheet of PVB (forming a laminate or intermediate layer 142a) is placed onto the adhesive coated surface of the PMMA layer 144a. A primer coating, for example, an optically clear adhesion promoter, is placed onto the nesting surface of the polycarbonate base layer 140. The now coated polycarbonate base layer 140 is placed into contact with the thin sheet of PVB (forming the laminate or intermediate layer 142a) that covers the PMMA layer 144a, to form a product with three layers.

The polycarbonate base layer 140, at the non-coated surface, is now coated with the aforementioned primer coating. A second thin precut sheet of PVB (forming a laminate or intermediate layer 142b) is placed onto the adhesive coated surface. The other PMMA layer 144b is now coated with primer, as detailed above, and placed into contact with the exposed sheet of PVB (forming a laminate or intermediate layer 142b). A five layer uncured product with flush edges has been made. The five layer product is cured, by being vacuum bagged in an autoclave, as detailed above, to produce the resultant window 130, 130′.

There has been shown and described at least one preferred embodiment of a transparency for use with aircraft. It is apparent to those skilled in the art, however, that many changes, variations, modifications, and other uses and applications for the apparatus and its components are possible, and also such changes, variations, modifications, and other uses and applications which do not depart from the spirit and scope of the invention are deemed to be covered by the invention, which is limited only by the claims which follow.

What is claimed is:

1. An aviation transparency comprising:
a base layer including a polycarbonate polymer;
an upper layer including an acrylic polymer; and
an intermediate layer including a polymeric material for confining defects to the base layer and the upper layer, the intermediate layer between the base layer and the outer layer.

2. The aviation transparency of claim 1 including an aircraft window.

3. The aviation transparency of claim 1 wherein said polycarbonate polymer is an optical grade polycarbonate.

4. The aviation transparency of claim 1 wherein said acrylic polymer is Polymethyl Methacrylate (methyl 2-methylpropenoate) (PMMA).

5. The aviation transparency of claim 1 wherein said intermediate layer is Polyvinyl butyral resin (PVB).

6. An aviation transparency comprising:
a polycarbonate polymer central layer;
a first acrylic polymer layer adhered to one side of said central layer; and
a second acrylic polymer layer adhered to another side of said central layer.

7. The aviation transparency of claim 6 wherein said first acrylic layer is adhered to said central layer using a first intermediate layer of polymeric material and said second acrylic layer is adhered to said central layer using a second intermediate layer of polymeric material.

8. A method of making an aircraft transparency, said method comprising:
injection compression molding a polycarbonate base layer;
injection compression molding an acrylic outer layer such that said outer layer nests with said base layer;
adhering said base and outer layers to one another using an optically-clear adhesion promoter to form an assembly; and
curing said assembly.
